(19) United States
(12) Patent Application Publication
(10) Pub. No.: US 2026/0087092 A1
(43) Pub. Date: Mar. 26, 2026

(54) APPARATUS AND METHOD FOR SELECTING ADAPTIVE SAMPLE DATA

(71) Applicant: POSTECH RESEARCH AND BUSINESS DEVELOPMENT FOUNDATION, Pohang-si (KR)

(72) Inventors: Min Su CHO, Pohang-si (KR); Jeong Been YOON, Pohang-si (KR)

(73) Assignee: POSTECH RESEARCH AND BUSINESS DEVELOPMENT FOUNDATION, Pohang-si (KR)

(21) Appl. No.: 18/899,586

(22) Filed: Sep. 27, 2024

(30) Foreign Application Priority Data
Sep. 25, 2024 (KR) 10-2024-0129853

(51) Int. Cl. G06F 17/16

(52) U.S. Cl. CPC G06F 17/16

(57) ABSTRACT

An apparatus for selecting adaptive sample data, comprising: a memory in which a sample selection program is stored; and a processor configured to execute the sample selection program, wherein the sample selection program is configured to: receive target data input to a pre-learned artificial intelligence model, generate a first temporary data set by replacing the target data with first sample data included in a sample data set, generate a second temporary data set by replacing the target data with second sample data that is different from the first sample data included in the sample data set, compare the diversity of the first and second temporary data sets and diversity of the sample data set with each other, and change any one of the first and second temporary data sets of which the diversity comparison result satisfies a replacement condition to the sample data set.

### CROSS-REFERENCE TO RELATED APPLICATION

This application claims priority under 35 U.S. C § 119 to Korean Patent Application No. 10-2024-0129853 filed on Sep. 25, 2024, in the Korean Intellectual Property Office, the entire contents of which are hereby incorporated by reference.

### TECHNICAL FIELD

The disclosure relates to an apparatus and a method for selecting adaptive sample data. Specifically, the disclosure relates to an apparatus and a method for selecting adaptive sample data, which can select adaptive sample data for adapting an artificial intelligence model to a target data set in a data stream environment that is non-independent and identical distribution.

### BACKGROUND

The contents set forth in this section merely provide background information on the present embodiment and do not constitute the prior art.

In general, when it is desired to improve the performance of an artificial intelligence model that is learned through deep learning by adapting the model to a target data set, a method of learning is used through repeated input of the same target data several times. In this case, since a label is not set in the target data set, it is possible to adapt the artificial intelligence model to the target data set by utilizing the knowledge of a source data set in which a label is set.

However, on the spot, a situation may arise that requires immediate adaption of the artificial intelligence model to data that is input in real time without the source data set. For example, in case of a video with continuous input of frames, the frames that are continuously input have the characteristic of being highly correlated with each other, and thus the frames of the video have the property of non-independent and identical distribution. Due to the above-described property, when a data stream of the non-independent and identical distribution such as a video is given as input data of the artificial intelligence model that is applied on the spot, the artificial intelligence model is more likely to be biased toward a particular class.

Accordingly, there is a need for a technology that can prevent the artificial intelligence model from being biased and adapted to the specific class.

### PRIOR ART DOCUMENT

### Patent Document

(Patent Document 1) Korean Patent Application Publication No. 10-2023-0131698 (Title of Invention: Method and system for generating environment-adaptive deep learning model)

### SUMMARY

An object of the present disclosure is to generate a sample data set so that an artificial intelligence model can be adapted to target data without being biased toward a specific class by using the target data input to the artificial intelligence model applied to a data stream environment that is non-independent and identical distribution.

Further, an object of the present disclosure is to generate a sample data set having class diversity by using an output value of an artificial intelligence model for target data so that the artificial intelligence model is not biased toward a specific class.

Further, an object of the present disclosure is to generate a sample data set above a specific difficulty level by using an output value of an artificial intelligence model for target data.

The objects of the present disclosure are not limited to the objects mentioned above, and other objects and advantages of the present disclosure that have not been mentioned can be understood by the following description and will be more clearly understood by the embodiments of the present disclosure. Further, it will be readily appreciated that the objects and advantages of the present disclosure may be realized by the means set forth in the claims and combinations thereof.

According to some aspects of the disclosure, an apparatus for selecting adaptive sample data, comprises, a memory in which a sample selection program is stored, and a processor configured to execute the sample selection program, wherein the sample selection program is configured to: receive target data input to a pre-learned artificial intelligence model, generate a first temporary data set by replacing the target data with first sample data included in a sample data set, generate a second temporary data set by replacing the target data with second sample data that is different from the first sample data included in the sample data set, calculate diversity of the first and second temporary data sets and compare the diversity of the first and second temporary data sets and diversity of the sample data set with each other, and change any one of the first and second temporary data sets of which the diversity comparison result satisfies a replacement condition to the sample data set, wherein the sample data is the target data previously input to the artificial intelligence model, and wherein the diversity numerically indicates a degree of bias with which plural pieces of data included in one of the sample data set, the first temporary data set, and the second temporary data set are biased toward a specific class.

According to some aspects, the sample selection program calculates the diversity by calculating distinction and certainty of the first and second temporary data sets based on a prediction matrix for each of the first and second temporary data sets, wherein the prediction matrix is composed of output values of the artificial intelligence model for each data included in the temporary data set, wherein the distinction numerically indicates class diversity of the temporary data set and a difficulty level of the temporary data set, and wherein the certainty numerically indicates a difficulty level of the temporary data set.

According to some aspects, the sample selection program is configured to: measure the distinction by calculating a nuclear norm for the prediction matrix of the temporary data set, measure the certainty by calculating a Frobenius norm, and calculate the diversity through an operation using the distinction and the certainty.

According to some aspects, the sample selection program is configured to add the sample data replaced with the target data when the temporary data set is generated to a replacement list in case that the diversity of the temporary data set is higher than the diversity of the sample data set, and the certainty of the temporary data set is equal to or smaller than a threshold value.

According to some aspects, the sample selection program is configured to replace the target data with any one of the at least one sample data in case that the at least one sample data is included in the replacement list as a result of diversity comparison.

According to some aspects, the sample selection program is configured to: store the sample data replaced with the target data when a maximum diversity for the first and second temporary data sets and the temporary data set corresponding to the maximum diversity are generated, and replace the target data with the sample data to correspond to the temporary data set having the greatest diversity in case that the replacement list is in an empty state as the result of diversity comparison.

According to some aspects, the sample selection program is configured to: store the sample data replaced with the target data when a minimum certainty of the temporary data set and the temporary data set corresponding to the minimum certainty are generated, and replace the target data with the adaptive sample data to correspond to the temporary data set having the lowest certainty among the temporary data sets in case that the replacement list is in an empty state as the result of diversity comparison.

According to some aspects, the sample selection program is configured to: generate the sample data set by storing the target data as much as a specific size of the memory at the beginning of its operation, and measure the diversity of the sample data set.

According to some aspects of the disclosure, a method for selecting adaptive sample data using an apparatus for selecting adaptive sample data, the method comprising the steps of: receiving target data input to a pre-learned artificial intelligence model; generating a first temporary data set by replacing the target data with first sample data included in a sample data set, and generating a second temporary data set by replacing the target data with second sample data that is different from the first sample data included in the sample data set; calculating diversity of each temporary data; comparing diversity of first and second temporary data sets and the diversity of the sample data set with each other; and changing any one of the first and second temporary data sets of which the diversity comparison result satisfies a replacement condition to the sample data set, wherein the sample data is the target data previously input to the artificial intelligence model, and wherein the diversity numerically indicates a degree of bias with which plural pieces of data included in one of the sample data set, the first temporary data set, and the second temporary data set are biased toward a specific class.

According to some aspects, the step of comparing the diversity calculates the diversity of the temporary data set by calculating distinction of the temporary data set and certainty of the temporary data set based on a prediction matrix for the temporary data sets, wherein the prediction matrix includes output values of the artificial intelligence model for each data included in the temporary data set, wherein the distinction numerically indicates class diversity of the temporary data set and a difficulty level of the temporary data set, and wherein the certainty numerically indicates a difficulty level of the temporary data set.

According to some aspects, the step of calculating the diversity measures the distinction by calculating a nuclear norm for the prediction matrix of the temporary data set, measures the certainty by calculating a Frobenius norm, and calculates the diversity of the temporary data set through an operation using the distinction and the certainty.

According to some aspects, the step of comparing the diversity includes the sample data replaced with the target data when the temporary data set is generated in a replacement list in case that the diversity of the temporary data set is higher than the diversity of the sample data set, and the certainty of the temporary data set is equal to or smaller than a threshold value.

According to some aspects, the step of changing to the sample data set replaces the target data with any one of the at least one sample data in case that the at least one sample data is included in the replacement list.

According to some aspects, the step of comparing the diversity stores the sample data replaced when a maximum diversity of the temporary data set and the temporary data set corresponding to the maximum diversity are generated, and wherein the step of changing to the sample data set replaces the target data with the sample data to correspond to the temporary data set for the maximum diversity in case that the replacement list is in an empty state.

According to some aspects, the step of comparing the diversity stores the sample data replaced when a minimum certainty of the temporary data set and the temporary data set corresponding to the minimum certainty are generated, and wherein the step of changing to the sample data set replaces the target data with the sample data to correspond to the temporary data set for the minimum certainty in case that the replacement list is in an empty state.

The apparatus and the method for selecting adaptive sample data of the present disclosure can prevent the artificial intelligence model from being biased toward the specific class by replacing the target data with the sample data so that the sample data set for adaption of the artificial intelligence model has class diversity when the artificial intelligence model is applied to the data stream environment that is the non-independent and identical distribution.

Further, since it is possible to update the sample data set by replacing the target data with the sample data so as to maintain the sample data set above the specific difficulty level, the performance of the artificial intelligence model can be prevented from being deteriorated.

Further, it is possible to effectively adapt the artificial intelligence model to the data stream environment that is the non-independent and identical distribution by generating the sample data having the class diversity and specific difficulty level.

In addition to what is described above, specific effects of the present disclosure will be described together while illustrating the following specific details for carrying out the present disclosure.

### BRIEF DESCRIPTION OF THE DRAWINGS

FIG. 1 is a block diagram schematically illustrating the constitution of an apparatus for selecting adaptive sample data according to an embodiment of the present disclosure.

FIGS. 2 to 10 are exemplary diagrams explaining an operation of the apparatus for selecting adaptive sample data.

FIG. 11 is a flowchart explaining a method for selecting sample data according to an embodiment of the present disclosure.

### DETAILED DESCRIPTION

The terms or words used in the disclosure and the claims should not be construed as limited to their ordinary or lexical meanings. They should be construed as the meaning and concept in line with the technical idea of the disclosure based on the principle that the inventor can define the concept of terms or words in order to describe his/her own inventive concept in the best possible way. Further, since the embodiment described herein and the configurations illustrated in the drawings are merely one embodiment in which the disclosure is realized and do not represent all the technical ideas of the disclosure, it should be understood that there may be various equivalents, variations, and applicable examples that can replace them at the time of filing this application.

Although terms such as first, second, A, B, etc. used in the description and the claims may be used to describe various components, the components should not be limited by these terms. These terms are only used to differentiate one component from another. For example, a first component may be referred to as a second component, and similarly, a second component may be referred to as a first component, without departing from the scope of the disclosure. The term ‘and/or’ includes a combination of a plurality of related listed items or any item of the plurality of related listed items.

The terms used in the description and the claims are merely used to describe particular embodiments and are not intended to limit the disclosure. Singular forms are intended to include plural forms unless the context clearly indicates otherwise. In the application, terms such as “comprise,” “comprise,” “have,” etc. should be understood as not precluding the possibility of existence or addition of features, numbers, steps, operations, components, parts, or combinations thereof described herein.

Unless otherwise defined, the phrases “A, B, or C,” “at least one of A, B, or C,” or “at least one of A, B, and C” may refer to only A, only B, only C, both A and B, both A and C, both B and C, all of A, B, and C, or any combination thereof.

Unless being defined otherwise, all terms used herein, including technical or scientific terms, have the same meaning as commonly understood by those skilled in the art to which the disclosure pertains.

Terms such as those defined in commonly used dictionaries should be construed as having a meaning consistent with the meaning in the context of the relevant art, and are not to be construed in an ideal or excessively formal sense unless explicitly defined in the application. In addition, each configuration, procedure, process, method, or the like included in each embodiment of the disclosure may be shared to the extent that they are not technically contradictory to each other.

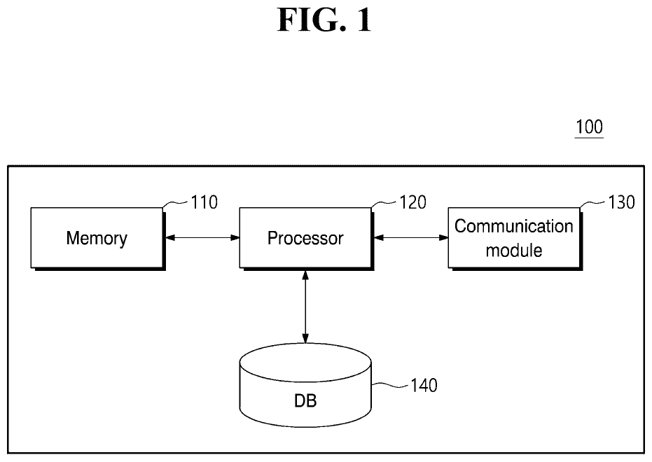

Hereinafter, with reference to FIGS. 1 to 11, an apparatus and a method for selecting adaptive sample data according to embodiments of the present disclosure will be described.

First, referring to FIGS. 1 to 10, an apparatus for selecting adaptive sample data will be described.

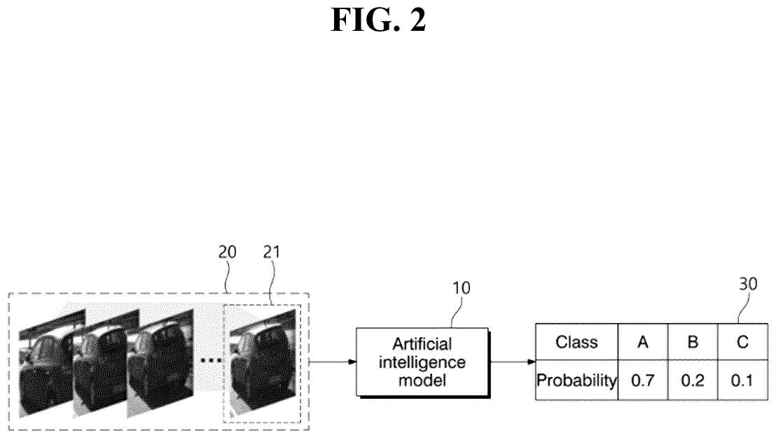

FIG. 1 is a block diagram schematically illustrating the constitution of an apparatus for selecting adaptive sample data according to an embodiment of the present disclosure, and FIGS. 2 to 10 are exemplary diagrams explaining an operation of the apparatus for selecting adaptive sample data.

Referring to FIGS. 1 and 2, when a pre-learned artificial intelligence model is applied to an environment, in which a data stream that is non-independent and identical distribution is input, the apparatus 100 for selecting adaptive sample data generates an adaptive sample data set by using target data input in real time so that the artificial intelligence model can be adapted to the input target data without being biased toward a specific class, and updates the adaptive sample data set by replacing the target data with any one of plural pieces of adaptive sample data based on a replacement condition.

Here, the independent and identical distribution (iid) means a multidimensional random variable in which plural elements are independent of each other and follow the identical probability distribution. That is, a data stream that is the non-independent and identical distribution means that the frames of the data stream are correlated with each other.

Specifically, the apparatus 100 for selecting adaptive sample data may receive target data that is input to an artificial intelligence model, and may generate a plurality of temporary data sets by replacing the target data with the plural pieces of sample data included in the sample data set with the target data in a one-to-one manner. Further, the apparatus 100 for selecting adaptive sample data may compare diversity values indicating the degrees of bias of each temporary data set and the sample data set, and may replace the target data with the sample data so as to correspond to the temporary data set if the diversity comparison result satisfies the replacement condition.

Here, the sample data is the target data that is previously input to the artificial intelligence model, and the diversity is a numerical representation of the degree of bias of the plural pieces of data included in the data set toward a specific class, and may be calculated based on the output value of the artificial intelligence model for each data.

In order to perform the above-described operation, the apparatus 100 for selecting adaptive sample data may include a memory 110 and a processor 120.

The memory 110 may store therein a sample selection program that selects sample data to be replaced with the target data that is input to the artificial intelligence model among the plural pieces of sample data included in the sample data set. The memory 110 may be interpreted as a general term for a nonvolatile storage device that maintains stored information even if power is not supplied thereto and a volatile storage device that requires the power to maintain the stored information. Further, the memory 110 may perform a function of temporarily or permanently storing data that is processed by the processor 120. The memory 110 may include magnetic storage media or flash storage media in addition to the volatile storage device that requires the power to maintain the stored information, but the scope of the present disclosure is not limited thereto.

By executing the sample selection program stored in the memory 110, the processor 120 may receive the target data which is each of frames of video data that is input to the pre-learned artificial intelligence model and an output of the artificial intelligence model for the target data, select any one of the plural pieces of sample data based on the replacement condition, and replace the target data with the selected sample data. Through this, it is possible to update the sample data set 40 so that the artificial intelligence model is not biased toward a specific class. Here, the artificial intelligence module may be a deep learning model that receives and processes a data stream such as a video in real time.

Referring to FIGS. 2 to 10, the operation of the sample selection program will be described in detail.

The sample selection program may receive target data 21 which is each frame of video data 20 that is input to a pre-learned artificial intelligence model 10 and an output value 30 of the artificial intelligence model for the target data 21.

At the beginning of the operation of the sample selection program, the sample data set 40 has not been generated, and the sample selection program may generate the sample data set 40 by storing the target data 21 as much as a specific size of the memory at the beginning of the operation. Here, the sample selection program and the artificial intelligence model may be stored in the same memory 110 or in different memories.

After the sample data set 40 is generated, the sample selection program may update the sample data set 40 so that the artificial intelligence model 10 is not biased toward the specific class by replacing the target data 21 with any one of the sample data 41 included in the sample data set 40.

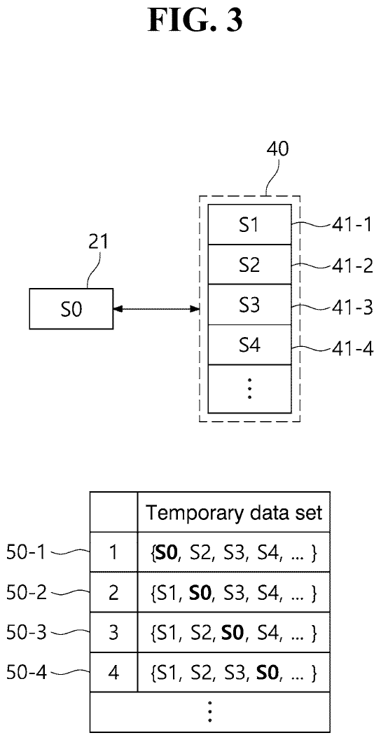

Specifically, referring to FIG. 3, the sample selection program generates a plurality of temporary data sets 50 by sequentially replacing the target data 21 with the plural pieces of sample data 41 included in the sample data set 40. The first temporary data set 50-1 may be generated by replacing the target data 21 with the first sample data 41-1, and the second temporary data set 50-2 may be generated by replacing the target data 21 with the second sample data 41-2. As described above, the sample selection program may generate the plurality of temporary data sets 50 by replacing the target data 21 with the entire sample data 41 in a one-to-one manner.

In this case, the sample selection program may generate the temporary data sets 50 simultaneously with generating a prediction matrix 70 for the temporary data sets 50. The prediction matrix may be an output value of the artificial intelligence model for the plural pieces of data included in the data set, and may be composed of prediction values for the classes.

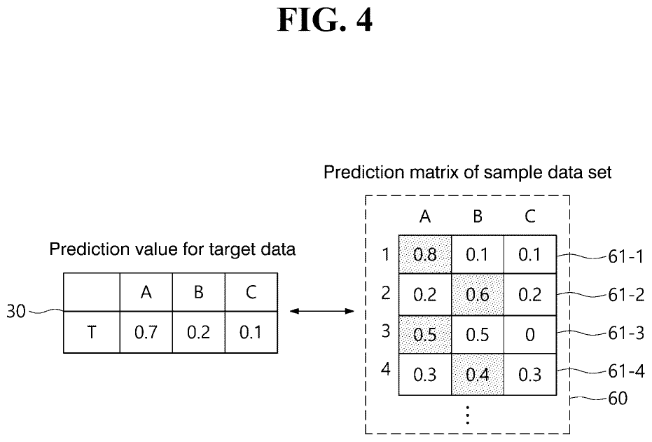

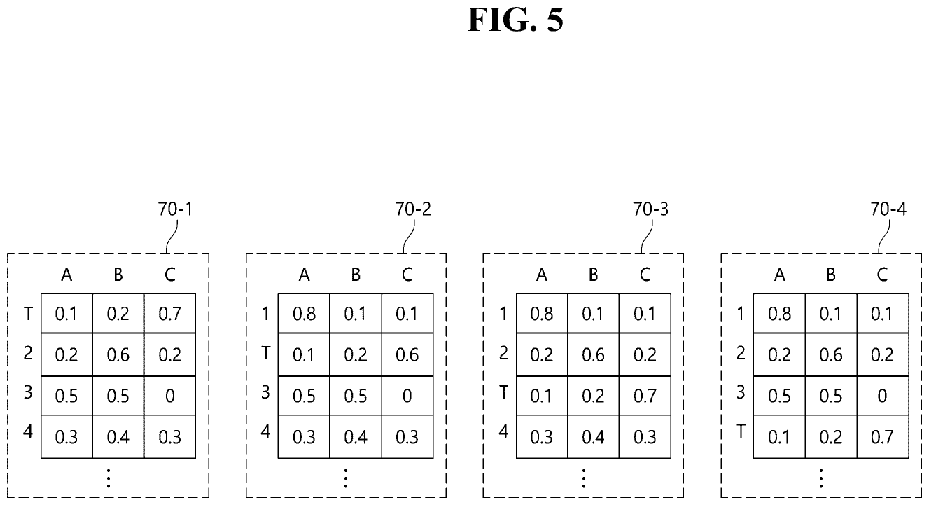

Referring to FIGS. 4 and 5, when the target data 21 is sequentially replaced with the plural pieces of sample data 41 included in the sample data set 40, the prediction matrix 70 for each of the temporary data sets 50 may be generated by replacing an output value 30 of the artificial intelligence model for the target data 21 with an output value 61 of the artificial intelligence model for the corresponding sample data 41 in a prediction matrix 60 of the sample data set 40. Here, the prediction matrix 60 of the sample data set 40 may be generated at the beginning of the operation of the sample selection program.

Referring to FIG. 5, the first prediction matrix 70-1 may be a prediction matrix for the first sample data set 50-1, and may include the output value 30 of the artificial intelligence model for the target data 21 instead of the output value 61-1 of the artificial intelligence model for the first sample data 41-1 in the prediction matrix 60 of the sample data set 40. The second prediction matrix 70-2 represents, as a matrix, the output value for the second temporary data set 50-2 including the target data 21 instead of the second sample data 41-2, and the third prediction matrix 70-3 represents, as a matrix, the output value for the third temporary data set 50-3 including the target data 21 instead of the third sample data 41-3.

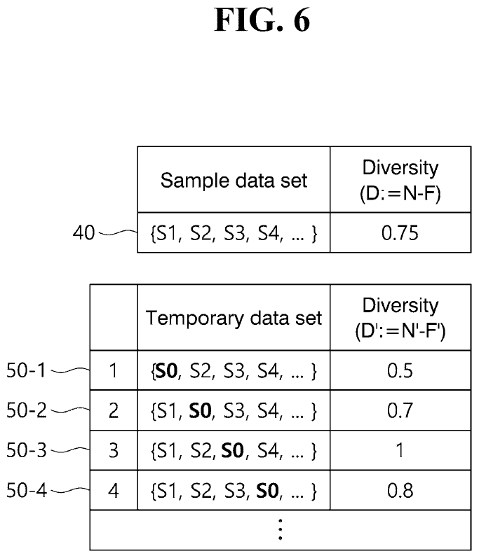

Thereafter, referring to FIG. 6, the sample selection program may calculate diversity D′ for each temporary data set 50 based on the prediction matrix 70 of each temporary data set 50. Specifically, the sample selection program may calculate the diversity D′ by calculating distinction N′ for the temporary data set 50 and certainty F′ for the temporary data set 50 based on the prediction matrix 70 for each of the temporary data sets 50 illustrated in FIG. 5.

Here, the diversity D numerically indicates how many different classes the data constituting the temporary data set 50 is divided into, and certainty F numerically indicates how accurately the artificial intelligence model 10 predicts the data constituting the temporary data set 50. For example, if the diversity D is high, it means that the data constituting the temporary data set 50 has been divided into various classes, and if the certainty F is high, it means that the prediction accuracy of the artificial intelligence model 10 for the data constituting the temporary data set 50 is high. That is, if the value of the diversity D is large, it means that the degree of bias toward the specific class is relatively low, and if the value of the certainty F is large, it means that the difficulty level is relatively low.

In addition, the distinction N has a value that reflects the diversity D and the certainty F, and numerically indicates the degree of bias with which the data set is biased toward the specific class and the difficulty level of the data set. If the value of the distinction N is large, it may mean that the degree of bias toward the specific class is relatively low or the difficulty level becomes low, and if the value of the distinction N is small, it may mean that the degree of bias toward the specific class is relatively high or the difficulty level becomes high.

Further, the sample selection program may compute the distinction N′ of the temporary data set 50 by calculating a nuclear norm for the prediction matrix 70, and may measure the certainty F′ of the temporary data set 50 by calculating a Frobenius norm for the prediction matrix 70. In addition, through operations using the distinction N′ and the certainty F′, as shown in FIG. 6, the diversity D′ for the temporary data set 50 can be calculated.

In FIG. 6, the diversity D′ has a value obtained by subtracting the certainty F′ from the distinction N′, and may have a large value in case of high distinction N′ or low certainty F′. However, the meaning of the value of the diversity D′ is not limited thereto, and according to mathematical expressions for calculating the diversity D′, it may be indicated that as the diversity value becomes smaller, the degree of bias becomes lower

Thereafter, the sample selection program compares the diversity D of the sample data set 40 and the diversity D′ of the temporary data set 50 with each other, and if the comparison result satisfies the replacement condition, the sample selection program replaces the target data 21 with the sample data 41 so as to correspond to the corresponding temporary data set 50. Here, the diversity D of the sample data set 40 may be calculated when the sample data set 40 is generated, and in the same manner as a process of calculating the diversity D′ of the temporary data set 50, the distinction N and the certainty F for the prediction matrix 60 of the sample data set 40 may be calculated, and the diversity D of the sample data set 40 may be calculated through an operation using the same.

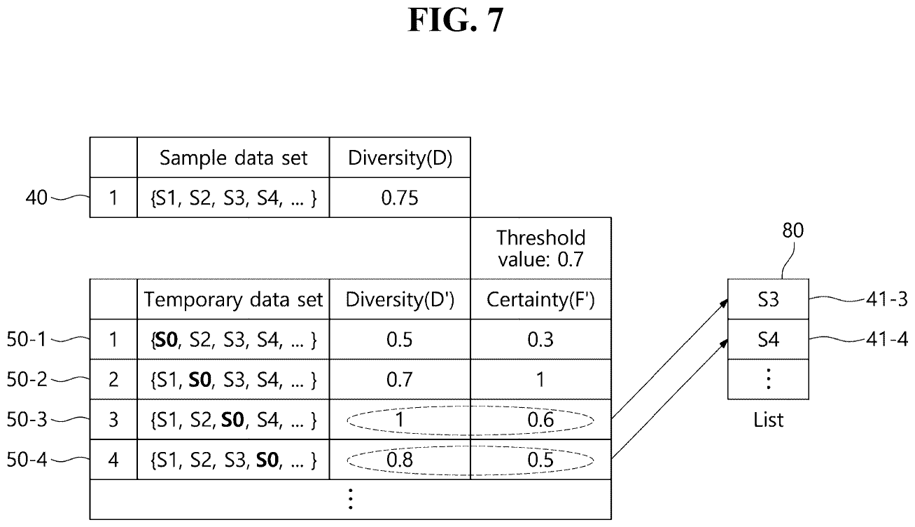

Referring to FIG. 7, an operation of replacing the target data 21 with the sample data 41 will be described in detail. The sample selection program may add the sample data 41 replaced with the target data 21 based on the replacement condition to a replacement list 80. The replacement condition may be a case that the diversity D′ of the temporary data set 50 is lower than the diversity D of the sample data set 40. According to the replacement condition as above, if the diversity D′ of the temporary data set 50 is higher than the diversity D of the sample data set 40, the sample selection program may add the sample data 41 replaced with the target data 21 to the replacement list 80 when the temporary data set 50 is generated.

In the present embodiment, it is indicated that if the diversity value is large, the degree of bias becomes low, and since the value of the diversity D′ of the third temporary data set 50-3 and the fourth temporary data set 50-4 is larger than the value of the diversity D of the sample data set 40 in FIG. 7, the degree of bias of the third temporary data set 50-3 and the fourth temporary data set 50-4 is lower than that of the sample data set 40. Accordingly, when the third temporary data set 50-3 and the fourth temporary data set 50-4 are generated, the third sample data 41-3 and the fourth sample data 41-4 replaced with the target data 21 may be added to the replacement list 80. In this case, an index of the sample data 41 may be added.

Further, the sample selection program may additionally reflect the certainty F′ of the temporary data set 50 in the replacement condition. In this case, the replacement condition may be a case that the diversity D′ of the temporary data set 50 is higher than the diversity D of the sample data set 40, and the certainty F′ of the temporary data set 50 is equal to or smaller than a specific value. The certainty F′ that is equal to or smaller than the specific value means that the difficulty level of the temporary data set 50 is equal to or higher than the specific difficulty level.

According to the replacement condition as above, in case that the diversity D′ of the temporary data set 50 is higher than the diversity D of the sample data set 40, and the certainty F′ of the temporary data set 50 is equal to or smaller than a threshold value, the sample selection program may add the sample data 41 replaced with the target data 21 when the temporary data set 50 is generated to the replacement list 80. For example, when the value of the diversity D′ of the temporary data set 50 is larger than the value of the diversity D of the sample data set 40, and the third temporary data set 50-3 and the fourth temporary data set 50-4, of which the certainty F′ is equal to or smaller than the threshold value, are generated, the third sample data 41-3 and the fourth sample data 41-4, being replaced with the target data 21, may be added to the replacement list 80.

As described above, although the sample selection program may update the sample data set 40 by using only the diversity D′ in which the distinction N′ and the certainty F′ are reflected in order to prevent the artificial intelligence model 10 from operating biased toward the specific class, the sample selection program may form the sample data set 40 above a specific difficulty level by additionally using the certainty F′, and thus can prevent the performance deterioration of the artificial intelligence model 10 while preventing the biased operation of the artificial intelligence model 10 at the same time.

Further, the sample selection program may store the maximum diversity D′ or the minimum certainty F′ for the entire temporary data set 50 in the process of comparing the diversity D′ of the entire temporary data set 50 and the diversity D of the sample data set 40 with each other, and may store the sample data 41 replaced with the target data 21 when the temporary data set 50 corresponding to the maximum diversity D′ or the temporary data set 50 corresponding to the minimum certainty F′ is generated. Here, the sample selection program may store an index of the sample data 41.

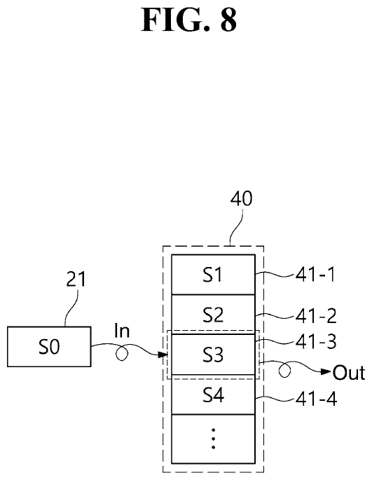

If at least one sample data 41 is included in the replacement list 80 after the operation of comparing the plural pieces of temporary data sets 50 with the replacement condition is performed, the sample selection program may replace the target data 21 with any one of the at least one sample data 41. For example, if the third sample data 41-3 and the fourth sample data 41-4 are included in the replacement list 80 as shown in FIG. 7, the sample selection program may update the sample data set 40 by replacing the target data 21 with the third sample data 41-3, or may update the sample data set 40 by replacing the target data 21 with the fourth sample data 41-4 as shown in FIG. 8. Here, the sample selection program may randomly select any one of the third sample data 41-3 and the fourth sample data 41-4, and may select the sample data 41 corresponding to the temporary data set 50 having higher diversity D′, that is, lower degree of bias, but the selection of the sample data is not limited thereto, and the sample selection program may select the sample data according to set selection criteria.

In contrast, if the replacement list 80 is in an empty state after comparing the diversities of the entire temporary data set 50 and the sample data set 40 with each other, the sample selection program may replace the target data 21 with the sample data 41 to correspond to the temporary data set 50 having the highest diversity D′ or the temporary data set 50 having the lowest certainty F′ among the temporary data sets 50. The case that the replacement list 80 is in an empty state corresponds to a case that there is not the temporary data set 50 that satisfies the above-described replacement condition, and in this case, the sample selection program may replace the target data 21 with the sample data 41 to correspond to the temporary data set 50 corresponding to the maximum diversity D′ or the minimum certainty F′.

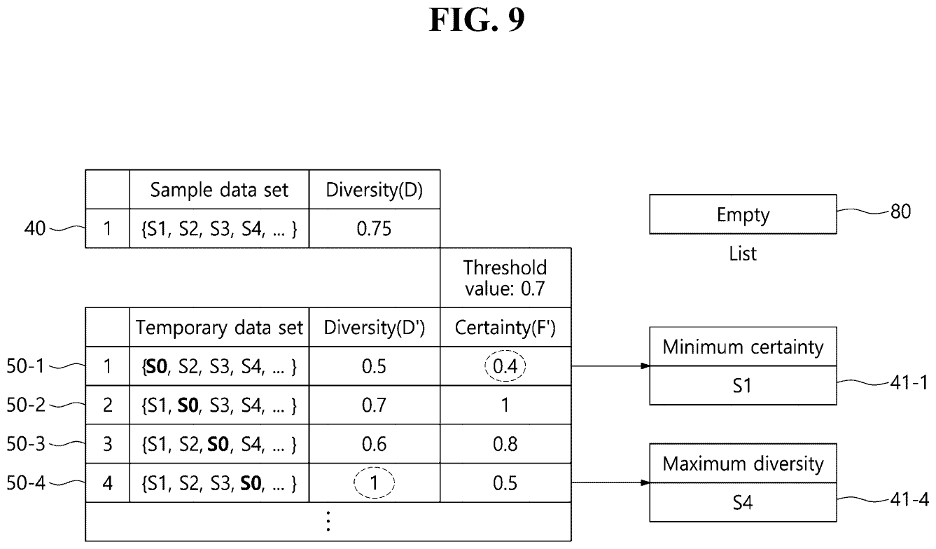

FIG. 9 represents a case where there is not the temporary data set 50 that satisfies the replacement condition. When performing an operation of comparing diversities representing the degrees of bias of the entire temporary data set 50 and sample data set 40, the sample selection program may store the first sample data 41-1 replaced with the target data 21 when the first temporary data set 50-1 having the lowest certainty F′, that is, having the highest difficulty level, is generated, and may store the fourth sample data 41-4 replaced with the target data 21 when the fourth temporary data set 50-4 having the highest diversity D, that is, having the lowest degree of bias, is generated. In this case, the index of the sample data 41 may be stored.

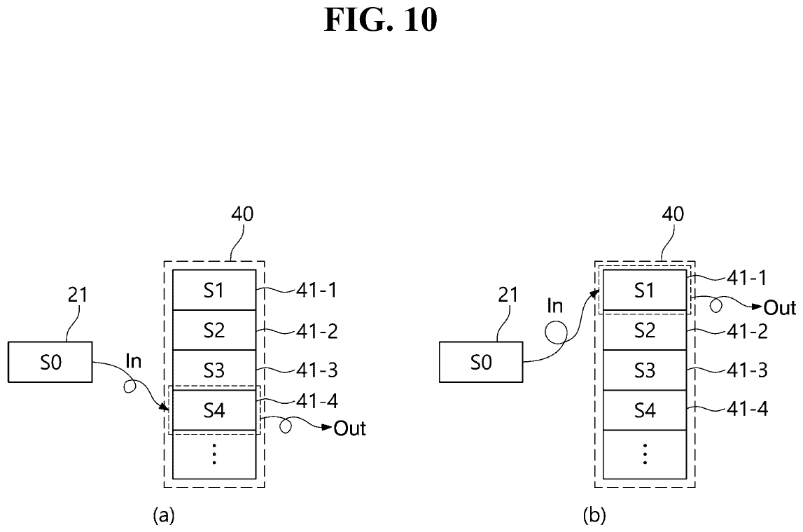

Thereafter, since the replacement list 80 is in an empty state, the sample selection program may update the sample data set 40 by replacing the target data 21 with the fourth sample data 41-4 to correspond to the fourth temporary data set 50-4 having the maximum diversity D′ as shown in (a) of FIG. 10 or by replacing the target data 21 with the first sample data 41-1 to correspond to the first temporary data set 50-1 having the minimum certainty F′ as shown in (b) of FIG. 10.

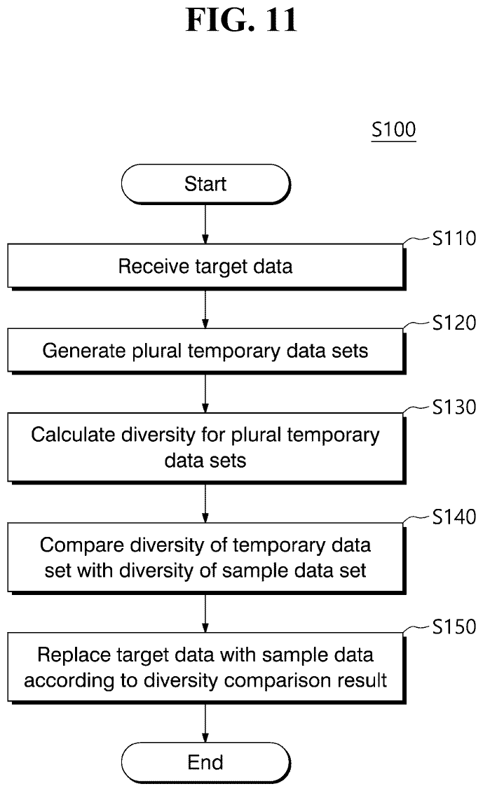

FIG. 11 is a flowchart explaining a method for selecting sample data according to an embodiment of the present disclosure.

Referring to FIGS. 1 and 11, a method for selecting sample data by using the apparatus 100 for selecting adaptive sample data will be described. The method S100 for selecting sample data may receive target data input to a pre-learned artificial intelligence model and an output of the artificial intelligence model for the target data (step S110), and generate a plurality of temporary data sets by replacing the target data with plural pieces of sample data included in a sample data set (step S120). Thereafter, the method S100 calculates diversity of each temporary data (step S130), compares the diversity of the temporary data with the diversity of the sample data set (step S140), and replaces the target data with the sample data of the sample data set to correspond to the temporary data set according to the diversity comparison result (step S150).

Here, the sample data is the target data that is previously input to the artificial intelligence model, and the diversity is a numerical representation of the degree of bias of the plural pieces of data included in the data set toward a specific class.

Then, referring to FIGS. 2 to 10, each process of the method S100 for selecting sample data will be described in detail.

First, referring to FIGS. 2 and 3, a process of receiving target data and an output value for the target data (step S110) will be described. In step S110, the apparatus 100 for selecting adaptive sample data receives target data 21 corresponding to each frame of video data 20 that is input to a pre-learned artificial intelligence model 10 and an output value 30 of the artificial intelligence model for the target data 21.

In this case, at the beginning of an operation of the apparatus 100 for selecting adaptive sample data, a sample data set 40 has not been generated, and the apparatus 100 for selecting adaptive sample data may determine whether to generate the sample data set 40, and in case that the sample data set 40 has not been generated, the apparatus 100 for selecting adaptive sample data may generate the sample data set 40 by storing the target data 21 as much as a specific size of the memory.

Next, a process of generating a plurality of temporary data sets (step S120) will be described. In step S120, the apparatus 100 for selecting adaptive sample data generates a plurality of temporary data sets 50 by sequentially replacing the target data 21 with the plural pieces of sample data 41 included in the sample data set 40. The first temporary data set 50-1 may be generated by replacing the target data 21 with the first sample data 41-1, and the second temporary data set 50-2 may be generated by replacing the target data 21 with the second sample data 41-2. As described above, the apparatus 100 for selecting adaptive sample data may generate the plurality of temporary data sets 50 by replacing the target data 21 with the entire sample data 41 in a one-to-one manner.

In this case, the apparatus 100 for selecting adaptive sample data may generate temporary data sets 50 simultaneously with generating a prediction matrix 70 for each of the temporary data sets 50. The prediction matrix may be an output value of the artificial intelligence model 10 for the data included in the data set, and may be composed of prediction values for the classes.

Referring to FIGS. 4 and 5, when the target data 21 is sequentially replaced with the plural pieces of sample data 41 included in the sample data set 40, the apparatus 100 for selecting adaptive sample data may generate the prediction matrix 70 for each of the temporary data sets 50 by replacing an output value 30 of the target data 21 with an output value 61 of the corresponding sample data 41 in the prediction matrix 60 of the sample data set 40. Here, the prediction matrix 60 of the sample data set 40 may be generated at the beginning of the operation of the apparatus 100 for selecting the sample data.

The first prediction matrix 70-1 illustrated in FIG. 5 may be a prediction matrix for the first sample data set 50-1, and may include the output value 30 of the target data 21 instead of the output value 61-1 of the first sample data 41-1 in the prediction matrix 60 of the sample data set 40. The second prediction matrix 70-2 represents a value for the second temporary data set 50-2, and the third prediction matrix 70-3 represents a value for the third temporary data set 50-3.

Thereafter, referring to FIG. 6, a process of calculating diversity for each temporary data (step S130) will be described. In step S130, the apparatus 100 for selecting adaptive sample data may calculate diversity D′ for each temporary data set 50 based on the prediction matrix 70 of each temporary data set 50. Specifically, the apparatus 100 for selecting adaptive sample data may calculate the diversity D′ by calculating distinction N′ for the temporary data set 50 and certainty F′ for the temporary data set 50 based on the prediction matrix 70 for each of the temporary data sets 50 illustrated in FIG. 5.

Here, the apparatus 100 for selecting adaptive sample data may compute the distinction N′ of the temporary data set 50 by calculating the nuclear norm for the prediction matrix 70, and may measure the certainty F′ of the temporary data set 50 by calculating the Frobenius norm for the prediction matrix 70. In addition, through operations using the distinction N′ and the certainty F', as shown in FIG. 6, the diversity D′ for the temporary data set 50 may be calculated.

In FIG. 6, the diversity D′ has a value obtained by subtracting the certainty F′ from the distinction N′, and it may be indicated that as the numerical value of the diversity D′ becomes large, the degree of bias toward the specific class becomes low. In addition, the value of the certainty F′ is large, it means that the difficulty level is relatively low, and the value of the distinction N′ is large, it means that the degree of bias toward the specific class becomes low or the difficulty level becomes low.

Then, a process of comparing the diversity D of the sample data set 40 and the diversity D′ of the temporary data set 50 with each other (step S140) will be described. In step S140, the apparatus 100 for selecting the sample data may select the sample data 41 replaced with the target data 21 by comparing the diversity D of the sample data set 40 and the diversity D′ of the temporary data set 50 with each other, and may add the selected sample data 41 to the replacement list 80.

Here, the diversity D of the sample data set 40 may be calculated when the sample data set 40 is generated, and in the same manner as a process of calculating the diversity D′ of the temporary data set 50, the distinction N and the certainty F for the prediction matrix 60 of the sample data set 40 may be calculated, and the diversity D of the sample data set 40 may be calculated through the operation using the same.

Referring to FIG. 7, a process of determining whether the result of comparing the diversity D of the sample data set 40 with the diversity D′ of the temporary data set 50 satisfies the replacement condition will be described in detail. The apparatus 100 for selecting the sample data may add the sample data 41 replaced with the target data 21 based on the replacement condition to the replacement list 80. The replacement condition may be a case that the diversity D′ of the temporary data set 50 is higher than the diversity D of the sample data set 40. According to the replacement condition as above, if the diversity D′ of the temporary data set 50 is higher than the diversity D of the sample data set 40, the apparatus 100 for selecting the sample data may add the sample data 41 replaced with the target data 21 to the replacement list 80 when the temporary data set 50 is generated.

Further, the apparatus 100 for selecting adaptive sample data may additionally reflect the certainty F′ of the temporary data set 50 in the replacement condition. In this case, the replacement condition may be a case that the diversity D′ of the temporary data set 50 is higher than the diversity D of the sample data set 40, and the certainty F′ of the temporary data set 50 is equal to or smaller than a threshold value.

According to the replacement condition as above, in case that the diversity D′ of the temporary data set 50 is higher than the diversity D of the sample data set 40, and the certainty F′ of the temporary data set 50 is equal to or smaller than the threshold value, the apparatus 100 for selecting adaptive sample data may add the sample data 41 replaced with the target data 21 when the temporary data set 50 is generated to the replacement list 80.

As shown in FIG. 7, since the diversity D′ of the third temporary data set 50-3 and the fourth temporary data set 50-4 is higher than the diversity D of the sample data set 40, and the certainty F′ thereof is equal to or smaller than the threshold value, the third sample data 41-3 replaced with the target data 21 when the third temporary data set 50-3 is generated and the fourth sample data 41-4 replaced with the target data 21 when the fourth temporary data set 50-4 is generated may be added to the replacement list 80. In this case, an index of the sample data 41 may be added to the replacement list 80.

Further, the apparatus 100 for selecting adaptive sample data may store the maximum diversity D′ or the minimum certainty F′ for the entire temporary data set 50 in the process of comparing the diversity D′ of the entire temporary data set 50 and the diversity D of the sample data set 40 with each other, and may store the sample data 41 replaced with the target data 21 when the temporary data set 50 corresponding to the maximum diversity D′ or the temporary data set 50 corresponding to the minimum certainty F′ is generated. Here, the apparatus 100 for selecting adaptive sample data may store an index of the sample data 41.

Next, a process of replacing the target data with the sample data to correspond to the temporary data set according to the diversity comparison result (step S150) will be described. In step S150, if at least one sample data 41 is included in the replacement list 80, the apparatus 100 for selecting adaptive sample data may replace the target data 21 with any one of the at least one sample data 41.

For example, if the third sample data 41-3 and the fourth sample data 41-4 are included in the replacement list 80 as shown in FIG. 7, the sample data set 40 may be updated by replacing the target data 21 with the third sample data 41-3, or the sample data set 40 may be updated by replacing the target data 21 with the fourth sample data 41-4 as shown in FIG. 8. Here, any one of the third sample data 41-3 and the fourth sample data 41-4 may be randomly selected, and the sample data 41 having higher diversity D′ may be selected, but the selection of the sample data is not limited thereto, and the sample data may be selected according to the set selection criteria.

As described above, although the apparatus 100 for selecting adaptive sample data may update the sample data set 40 by using only the diversity D′ of the temporary data set 50, the apparatus 100 for selecting adaptive sample data may form the sample data set 40 above the specific difficulty level by additionally using the certainty F', and thus can prevent the performance deterioration of the artificial intelligence model 10.

In contrast, if there is not the temporary data set 50 that satisfies the replacement condition in step S140, and the replacement list 80 is in an empty state, the apparatus 100 for selecting adaptive sample data may replace the target data 21 with the sample data 41 to correspond to the temporary data set 50 having the highest diversity D′ or the temporary data set 50 having the lowest certainty F′ stored in step S140.

FIG. 9 represents a case where there is not the temporary data set 50 that satisfies the replacement condition. If there is not the sample data 41 added to the replacement list 80, the first sample data 41-3 replaced with the target data when the first temporary data set 50-1 having the lowest certainty F′ is generated or the fourth sample data 41-4 replaced with the target data 21 when the fourth temporary data set 50-4 having the highest diversity D′ may be stored.

Thereafter, in step S150, the apparatus 100 for selecting adaptive sample data may update the sample data set 40 by replacing the target data 21 with the fourth sample data 41-4 to correspond to the fourth temporary data set 50-4 having the maximum diversity D′ as shown in (a) of FIG. 10 or by replacing the target data 21 with the first sample data 41-1 to correspond to the first temporary data set 50-1 having the minimum certainty F′ as shown in (b) of FIG. 10.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims. It is therefore desired that the embodiments be considered in all respects as illustrative and not restrictive, reference being made to the appended claims rather than the foregoing description to indicate the scope of the disclosure.

1. An apparatus for selecting adaptive sample data, comprising:
a memory in which a sample selection program is stored; and
a processor configured to execute the sample selection program, wherein the sample selection program is configured to:
receive target data input to a pre-learned artificial intelligence model, generate a first temporary data set by replacing the target data with first sample data included in a sample data set, generate a second temporary data set by replacing the target data with second sample data that is different from the first sample data included in the sample data set, calculate diversity of the first and second temporary data sets and compare the diversity of the first and second temporary data sets and diversity of the sample data set with each other, and change any one of the first and second temporary data sets of which the diversity comparison result satisfies a replacement condition to the sample data set,
wherein the sample data is the target data previously input to the artificial intelligence model, and
wherein the diversity numerically indicates a degree of bias with which plural pieces of data included in one of the sample data set, the first temporary data set, and the second temporary data set are biased toward a specific class

2. The apparatus of claim 1, wherein the sample selection program calculates the diversity by calculating distinction and certainty of the first and second temporary data sets based on a prediction matrix for each of the first and second temporary data sets,
wherein the prediction matrix is composed of output values of the artificial intelligence model for each data included in the temporary data set,
wherein the distinction numerically indicates class diversity of the temporary data set and a difficulty level of the temporary data set, and
wherein the certainty numerically indicates a difficulty level of the temporary data set.

3. The apparatus of claim 2, wherein the sample selection program is configured to: measure the distinction by calculating a nuclear norm for the prediction matrix of the temporary data set, measure the certainty by calculating a Frobenius norm, and calculate the diversity through an operation using the distinction and the certainty.

4. The apparatus of claim 2, wherein the sample selection program is configured to add the sample data replaced with the target data when the temporary data set is generated to a replacement list in case that the diversity of the temporary data set is higher than the diversity of the sample data set, and the certainty of the temporary data set is equal to or smaller than a threshold value.

5. The apparatus of claim 4, wherein the sample selection program is configured to replace the target data with any one of the at least one sample data in case that the at least one sample data is included in the replacement list as a result of diversity comparison.

6. The apparatus of claim 5, wherein the sample selection program is configured to:
store the sample data replaced with the target data when a maximum diversity for the first and second temporary data sets and the temporary data set corresponding to the maximum diversity are generated, and
replace the target data with the sample data to correspond to the temporary data set having the greatest diversity in case that the replacement list is in an empty state as the result of diversity comparison.

7. The apparatus of claim 5, wherein the sample selection program is configured to:
store the sample data replaced with the target data when a minimum certainty of the temporary data set and the temporary data set corresponding to the minimum certainty are generated, and
replace the target data with the adaptive sample data to correspond to the temporary data set having the lowest certainty among the temporary data sets in case that the replacement list is in an empty state as the result of diversity comparison.

8. The apparatus of claim 1, wherein the sample selection program is configured to:
generate the sample data set by storing the target data as much as a specific size of the memory at the beginning of its operation, and measure the diversity of the sample data set.

9. A method for selecting adaptive sample data using an apparatus for selecting adaptive sample data, the method comprising the steps of:
receiving target data input to a pre-learned artificial intelligence model;
generating a first temporary data set by replacing the target data with first sample data included in a sample data set, and generating a second temporary data set by replacing the target data with second sample data that is different from the first sample data included in the sample data set;
calculating diversity of each temporary data;
comparing diversity of first and second temporary data sets and the diversity of the sample data set with each other; and
changing any one of the first and second temporary data sets of which the diversity comparison result satisfies a replacement condition to the sample data set,
wherein the sample data is the target data previously input to the artificial intelligence model, and
wherein the diversity numerically indicates a degree of bias with which plural pieces of data included in one of the sample data set, the first temporary data set, and the second temporary data set are biased toward a specific class.

10. The method of claim 9, wherein the step of comparing the diversity calculates the diversity of the temporary data set by calculating distinction of the temporary data set and certainty of the temporary data set based on a prediction matrix for the temporary data sets,
wherein the prediction matrix includes output values of the artificial intelligence model for each data included in the temporary data set,
wherein the distinction numerically indicates class diversity of the temporary data set and a difficulty level of the temporary data set, and
wherein the certainty numerically indicates a difficulty level of the temporary data set.

11. The method of claim 10, wherein the step of calculating the diversity measures the distinction by calculating a nuclear norm for the prediction matrix of the temporary data set, measures the certainty by calculating a Frobenius norm, and calculates the diversity of the temporary data set through an operation using the distinction and the certainty.

12. The method of claim 10, wherein the step of comparing the diversity includes the sample data replaced with the target data when the temporary data set is generated in a replacement list in case that the diversity of the temporary data set is higher than the diversity of the sample data set, and the certainty of the temporary data set is equal to or smaller than a threshold value.

13. The method of claim 12, wherein the step of changing to the sample data set replaces the target data with any one of the at least one sample data in case that the at least one sample data is included in the replacement list.

14. The method of claim 12, wherein the step of comparing the diversity stores the sample data replaced when a maximum diversity of the temporary data set and the temporary data set corresponding to the maximum diversity are generated, and
wherein the step of changing to the sample data set replaces the target data with the sample data to correspond to the temporary data set for the maximum diversity in case that the replacement list is in an empty state.

15. The method of claim 12, wherein the step of comparing the diversity stores the sample data replaced when a minimum certainty of the temporary data set and the temporary data set corresponding to the minimum certainty are generated, and
wherein the step of changing to the sample data set replaces the target data with the sample data to correspond to the temporary data set for the minimum certainty in case that the replacement list is in an empty state.
